(19) United States
(12) Patent Application Publication
(10) Pub. No.: US 2025/0138335 A1
(43) Pub. Date: May 1, 2025

(54) SPORTS STRAP NECKLACE

(71) Applicant: Ronald Fekete, Sanborn, NY (US)

(72) Inventor: Ronald Fekete, Sanborn, NY (US)

(21) Appl. No.: 18/497,561

(22) Filed: Oct. 30, 2023

(51) Int. Cl. G02C 3/00

(52) U.S. Cl. CPC G02C 3/003

(57) ABSTRACT

The present invention provides a a system for keeping eyeglasses from falling off when the eyeglasses are worn hanging down in front or back of the body, on top of the head, or covering the eyes. The innovation is shown in FIG. 1 and comprises an eyeglass holder (1) which slips over the arm of the eyeglasses and connects the eyeglasses to the eyewear system. The eyewear system is comprised of a cord (2) connected to a chain (5) by a clasp (4). The cord length is adjusted to fit the user by a sliding adjuster (3). The chain optionally holds an ornament (6).

### BACKGROUND

Eyeglass cords/chains/straps for holding eyeglasses around the neck so the glasses do not fall and are easily accessible when not worn over the eyes are well known. The cord/chain/strap is fastened to the arm of the eyeglass and draped loosely around the wearer's neck.

Eyeglass wearers frequently place glasses on the top of their head when not wearing glasses. When the eyeglass wearer does this the glasses can fall backward off the wearer's head and the eyeglasses and attached cord/chain/strap can be lost or damaged when they fall to the ground or dropped into deep water.

There remains a need for an eyeglass cord/chain/strap that can hold eyeglass from falling from the face or from the top of the head

### FIELD STATEMENT

The invention relates to a modified cord/chain/strap that has an at least one front chain/necklace connected to an at least one cord/chain/strap worn around the back of the head.

### SUMMARY

An objective of the presented innovation is to provide an eyewear system for a user. The eyewear system has a cord, a chain, and an adjustment means that allows the eyeglass cord to attach to the eyeglass frame at one end of the cord and to the chain at the other end of the cord, and the eyeglass cord is joined to a second identical eyeglass cord by the adjustment means. When said eyewear system is worn by the user, said chain is positioned proximate to the front of the neck and the joined eyeglass cords are worn at the back of the head or neck region of the user.

In one embodiment the cord has a holder at one end and a clasp at the opposite end and the clasp is connected to the chain at one end and the chain is connected to a second cord by a clasp at the second end of the chain and the cords are joined by the adjustment means. The eyewear system is incorporated into an eyeglass frame by the holders and the eyeglass frame is incorporated by the arms.

In one embodiment the holder, the cord and the chain are made of a flexible material. In an embodiment the flexible material can be a polymer material. In another embodiment the chain is made of a metal material. In another embodiment the cords and the chain are made of a combination of a metal and a flexible material. In another embodiment the chain, cord and holder are made of the same material.

Another part of the eyewear system is the adjustment means and, in an embodiment, this is a slider. The slider adjusts the length of the cords simultaneously.

In an embodiment the cord attaches to the chain by a male female connector.

In an embodiment the eyewear system prevents the glasses from falling to the back of without falling off the user, while the chain remains on the user's chest or neck. This is accomplished by the way the glasses are worn by the user, as follows: Placing the chain and eyeglass over the head so both are on the user's chest and the slider is behind the user's head near the neck and shoulders; and The user optionally places eyeglasses on the user's face in the eye region or on the top of the user's head while leaving the chain on the chest and the slider behind the user's head near the neck and shoulders. Thereby allowing the user to retain the ability to retrieve the eyeglasses if the eyeglasses fall from the top of the user's head.

In an embodiment the chain holds at least one decorative element.

In an embodiment the eyewear system is manufactured using 3D printing or traditional manufacturing methods known by those of skill in the manufacturing arts.

### BRIEF DESCRIPTION OF DRAWINGS

FIG. 1 shows a view of the cord with ends to attach to the eyeglass frame by the arms, a sliding adjustor, a clasp to attach to a chain, a chain, and an optional ornament.

FIG. 2 shows a view of the cord and chain attached to the eyeglass as worn when eyeglass is not on the user's face.

FIG. 3 shows a view of the eyeglass attached to the cord where the eyeglasses has fallen off the user's head and is prevented from falling off the user by the chain.

FIG. 4 shows another view of the eyeglasses attached to the cord where the eyeglasses has fallen off the user's head and is prevented from falling off the user by the chain.

FIG. 5 shows a view of the chain where the glasses are attached to the cord and worn on the user's head.

FIG. 6 shows a view of the chain where the glasses are attached to the cord and worn on the user's face.

FIG. 7 shows a view of the chain and cord with glasses attached and worn on the face.

### DETAILED DESCRIPTION

The terms used in this specification generally have their ordinary meanings in the art, within the context of the invention, and in the specific context where each term is used. Certain terms are discussed below, or elsewhere in the specification, to provide additional guidance to the practitioner in describing the compounds, compositions, and methods of the invention and how to make and use them. Moreover, it will be appreciated that the same thing can be said in more than one way. Consequently, alternative language and synonyms may be used for any one or more of the terms discussed herein, nor is any special significance to be placed upon whether or not a term is elaborated or discussed herein. The use of examples anywhere in this specification, including examples of any terms discussed herein, is illustrative only, and in no way limits the scope and meaning of the invention or of any exemplified term. Likewise, the invention is not limited to the examples presented.

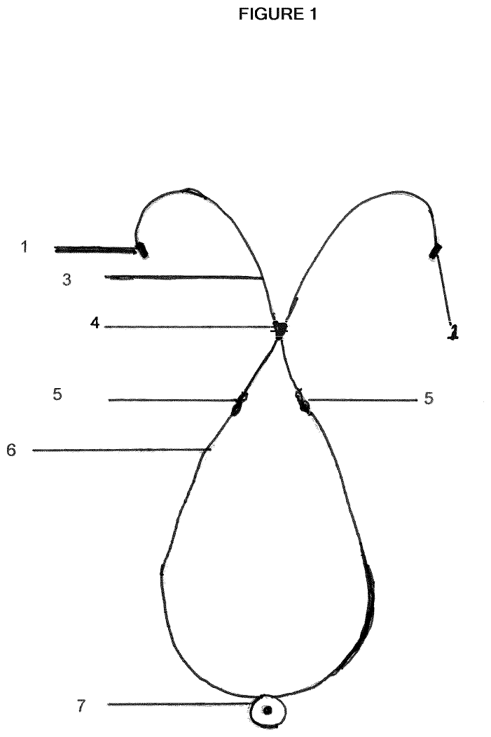

An objective of the presented innovation is to provide a system for keeping eyeglasses from falling off when the eyeglasses are worn hanging down in front or back of the body, on top of the head, or covering the eyes. The innovation is shown in FIG. 1 and comprises an eyeglass holder (1) which slips over the arm of the eyeglass and connects the eyeglass to the eyewear system. The eyewear system is comprised of a cord (2) connected to a chain (5) by a clasp (4). The cord length adjusts to fit the user by an adjuster (3). The chain optionally holds an ornament (6).

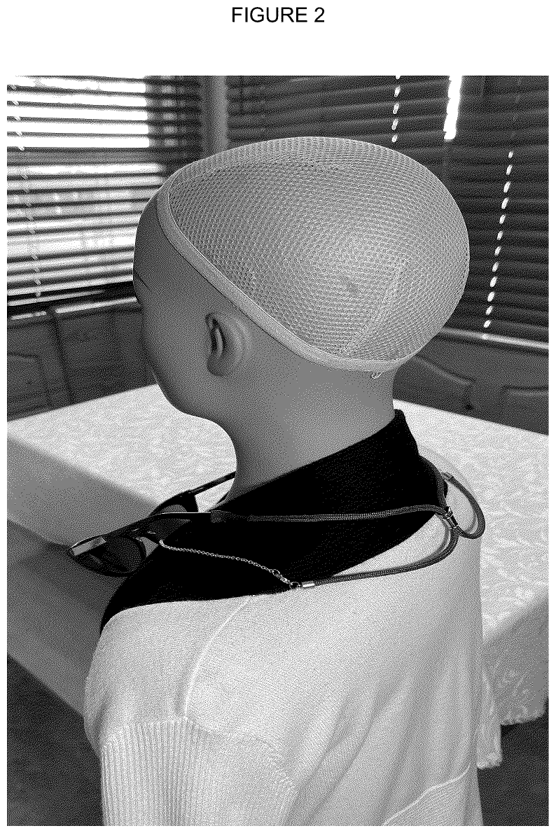

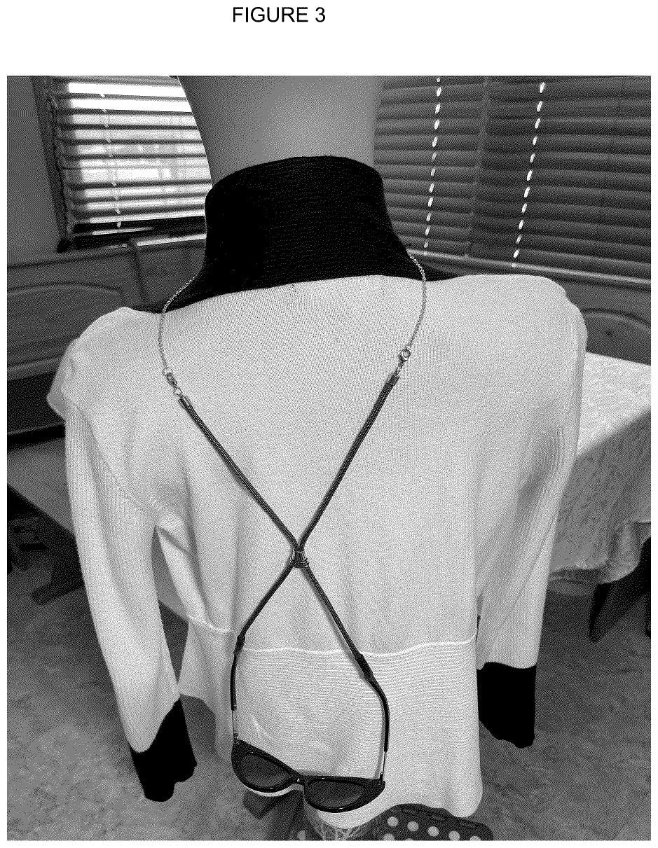

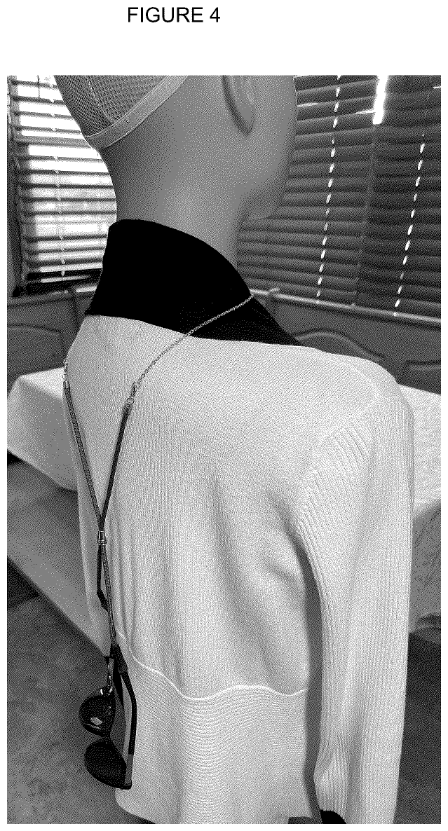

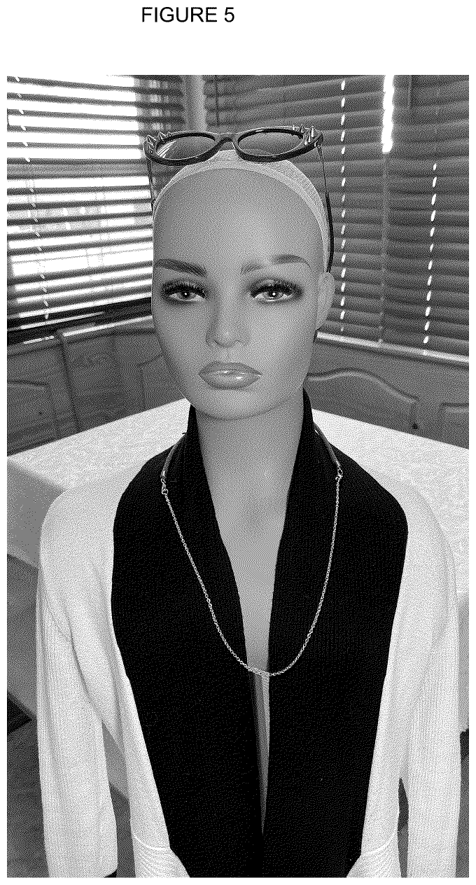

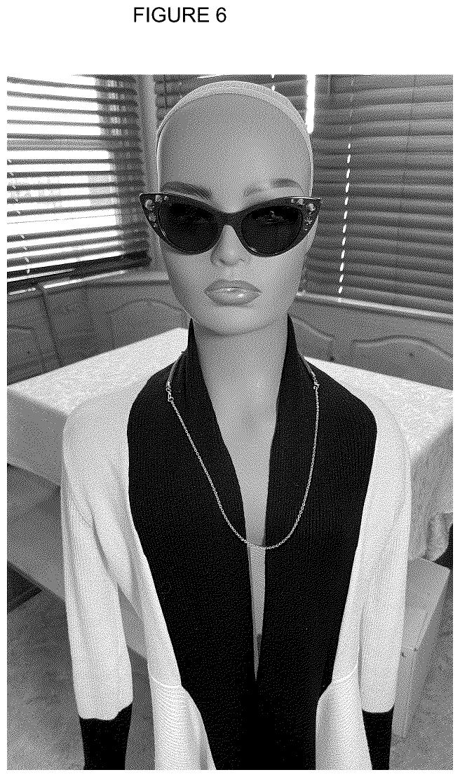

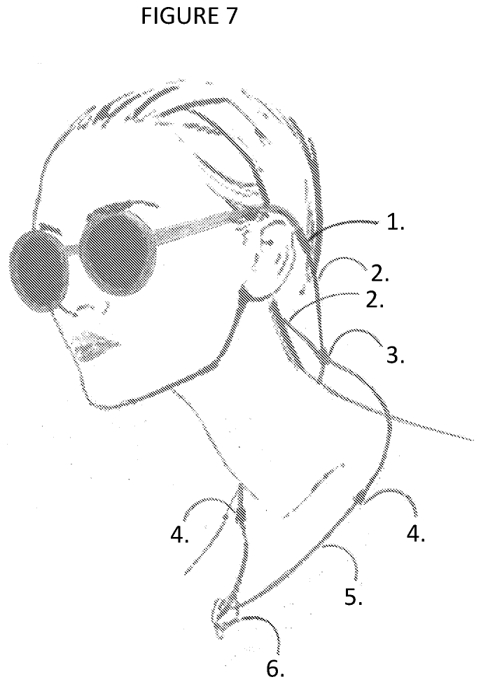

FIGS. 2-7 present views of the eyewear system as worn by a user.

The current inventor has produced and tested numerous models and discovered an improved sports strap.

ABOUT—As used herein, “about” or “approximately” shall generally mean within 20 percent, preferably within 10 percent, and more preferably within 5 percent of a given value or range. Other than in the operating examples, or where otherwise indicated, all numbers expressing quantities are to be understood as being modified in all instances by the term “about”.

AT LEAST—As used herein, the expression “at least” means one or more and thus includes individual components as well as combinations that still enable a working invention.

The eyeglass system has 2 identical cords, each connected at one end to the eyeglass frame by a holder (1). The eyeglass cord (2) may be made of any material that can be worn by a user in any weather condition as well as on land or in water. Non-limiting examples of material include fabric, metal, polymer, rope, and nylon. The cord may also be called a strap or a chain or any term that acts the same way the cord shown in the figures. The holder can be made of a variety of materials that can form a loop large enough to slip on the arm of the eyeglass. Once the holder is on the arm it must not slip off and must intentionally be removed from the eyeglass arm by the user. The arm of the eyeglass is part of the eyeglass frame that extends from the eyeglass frame to the area behind the user's ear. The holder will be attached to the arm, so the holder sits near the back of the user's ear. Non-limiting examples of the material the holder may be made of a flexible polymer material such as rubber. The holder may be fused to the cord by mechanical means or chemical means. A non-limiting example of a mechanical means would be a wire attached to the holder and the cord. A non-limiting example of a chemical means would be an adhesive on the holder and cord.

The cords have a clasp (4) on the end opposite the holder. The clasp is a two-sided clasp, one end of the clasp is attached to the cord. The other end of the clasp is attached to a chain (5). The chain/clasp/cord arrangement is identical on both ends. Non-limiting examples of the clasp are male/female connections, spring loaded connections, and double hooks. The chain can be made of the same or different material as the cord.

The eyeglass cords are joined by an adjustment means (also called an adjuster or slider) (3). The adjuster can be fixed by holding the cords together without moving. The adjuster may hold the cords together while sliding up and down on the cords to fit the eyeglass system in a comfortable length for the user.

The eyeglass cords must go over the head and be long enough to come back over and to the front of the face.

If the user has long hair, the eyeglass system can be concealed by a user's hair when wearing.

The eyeglass chain may optionally have at least one decorative element. A non-limiting example of a decorative element may be a charm, a gemstone, or a crystal. The user may choose to not have a charm or to add several different charms to the chain.

The chain is a separate piece from the cord and although the chain and cord may be made of the same or different material, they are separate and must by joined by the clasp.

The user herein is a human of any gender or age.

INCORPORATED—To unite with something else to form a whole

3D PRINTING3D printing or additive manufacturing is the construction of a three-dimensional object from a CAD model or a digital 3D model. It can be done in a variety of processes in which material is deposited, joined or solidified under computer control,^{[2]} with material being added together (such as plastics, liquids or powder grains being fused), typically layer by layer.

What is claimed is:

1. An eyewear system for a user, comprising:
a cord:
a chain; and
an adjustment means,
wherein the cord has a holder at one end and a clasp at the opposite end,
the clasp is connected to the chain at one end of the chain,
the chain is connected to a second cord by a clasp at the second end of the chain,
the eyeglass cords are joined by the adjustment means, and
said eyeglass frame is joined to an eyeglass by the cords.

2. The eyewear system as recited in claim 1, wherein the eyewear system is incorporated into the eyeglass frame by the holders.

3. The eyewear system as recited in claim 2, wherein said eyeglass frame is incorporated by the arms.

4. The eyewear system as recited in claim 1, wherein said cord is made of a flexible material.

5. The eyewear system as recited in claim 1, wherein said chain is made of a flexible material.

6. The eyewear system as recited in claim 1, wherein said chain is made of a metal material.

7. The eyewear system as recited in claim 1, wherein said cords are made of a combination of a metal and a flexible material.

8. The eyewear system as recited in claim 1, wherein said chain is made of a combination of a metal and a flexible material.

9. The eyewear system of claim 1, wherein the adjustment means is a slider.

10. The eyewear system of claim 1, wherein the cord attaches to the chain by a male female connector.

11. An eyewear system as recited in claim 9, wherein the slider adjusts the length of the cords simultaneously.

12. The eyewear system as recited in claim 1, wherein the eyewear system is worn by:
a. Placing the chain and eyeglass over the head so both are on the user's chest and the slider is behind the user's head near the neck and shoulders; and
b. The user optionally places eyeglasses on the user's face in the eye region or on the top of the user's head while leaving the chain on the chest and the slider behind the user's head near the neck and shoulders.

13. The eyewear system of claim 12, wherein the glasses can fall to the back of the head without falling off the user, while the chain remains on the user's chest or neck.

14. The eyewear system of claim 1, wherein the user retains the ability to retrieve the eyeglasses if the eyeglasses fall from the top of the user's head.

15. The eyewear system of claim 2, wherein the holders are flexible.

16. The eyewear system of claim 15, wherein the holders are composed of a flexible polymer material.

17. The eyewear system of claim 1, wherein the chain, the holder, and the cord are made of the same material.

18. The eyewear system of claim 1, wherein the chain, the holder and the cord are made of different material

19. The eyewear system of claim 1, wherein the chain holds at least one decorative element.

20. The eyewear system of claim 1, wherein the eyewear system is manufactured using 3D printing.
